(19) United States
(12) Patent Application Publication
(10) Pub. No.: US 2006/0192431 A1
(43) Pub. Date: Aug. 31, 2006

(54) Electricity distribution equipment

(76) Inventor: Tsukasa Shirai, Toyohasi-si (JP)

Correspondence Address: Tsukasa Shirai, 143-1, Hananaka-tyou, Toyohasi-si, Aichi, JP

(21) Appl. No.: 11/400,133

(22) Filed: Apr. 10, 2006

(30) Foreign Application Priority Data
Mar. 31, 2004 (JP) P2004-132209

(51) Int. Cl. B60L 1/00; H02G 3/00

(52) U.S. Cl. 307/10.1; 136/244

(57) ABSTRACT

The electricity distribution equipment for the car equipment which is equipped with the solar panel of at least two kinds of ways of connecting to an ordinary vehicle, and the equipment which connected a solar panel +pole and a −pole with the end and the end of car body metal.

### BACKGROUND OF THE INVENTION

There are goods which resemble always the battery of the motorcar in the parallel nexus and do the solar panel of the feeble generation of electricity. These goods are not the one which the electricity made purpose of the low pollution by making an appeal point numerous eyes more somewhat than the general car. The invention this time to load a motorcar with the medium-size and large-scale solar panel is the equipment which finds out substantial exhaust reduction.

### SUMMARY OF THE INVENTION

When having always made the medium-size and large-scale solar panel the battery of the motorcar in the parallel nexus connecting, it became a battery of the motorcar lifetime early. Therefore, it supposes only that the connection is a small solar panel in always the car battery, the way of using a basic target of the electric power entry to the car battery is the connection in car use which connects with the battery only in case of “on” or “acc” from the big solar panel when twisting the key of the car by the ignition, it supposed that it is possible to input electricity from the big solar panel in using a toggle switch before the car starts out, too, and that the rapidity charging formed in the car battery, too.

This equipment brings the electric anticorrosion phenomenon to car itself and the body and all the parts of the car and so on don't become dirty than the past. Also, even if it was dirty, the state of being stuck was weak and it became easy for the dirt to come off. The blaze by the car shampoo when after loaded with the invention this time, it became the neighborhood of being duple.

Therefore, as the wiring by the the electric anticorrosion exclusive use, have made a solar panel +pole and a −pole connect with the end and the end of the body metal of the car and it put them on the car. With this, the electric current flowed through the car body and the electric anticorrosion phenomenon occurred.

With the invention which was described above the above, the mileage improved dramatically. The decline of the engine number of rotations of the car occurred and that the operation tiring of the car is done decreased sharply.

### BRIEF DESCRIPTION OF THE DRAWINGS

FIG. 1 is the squint figure of this invention.

FIG. 2 is implementation example 1. It shows wiring by the car battery, FIG. 1Fa and FIG. 1Fb. It is the basic model of this invention.

FIG. 3 is implementation example 2. The wiring to the car battery and the structure of the solar panel equipment to load a car with. When huge-izing and dividing the solar panel which is equivalent to 2•24 of FIG. 3, the 2•26 part and making load it, excluding the case of the front desk glass window in the car and the case of the rear glass window in the car for full use in the car, on the roof of the car, on the bonnet, the solar panel must be put to the transversal directions such as the door of the car.

FIG. 4 is implementation example 3. The wiring to the car battery and the structure of the solar panel equipment to load a car with. When huge-izing and dividing the solar panel which is equivalent to 3•24 of FIG. 4, the 3•26 part and making load it, excluding the case of the front desk glass window in the car and the case of the rear glass window in the car for full use in the car, on the roof of the car, on the bonnet, the solar panel must be put to the transversal directions such as the door of the car.

FIG. 5: The state of the shutter which is on the small solar panel of 1•9 of FIG. 2, 2•9 of FIG. 3, 3•9 of FIG. 4

FIG. 6: The solar panel of Fc of FIG. 1. It uses to use the electric anticorrosion phenomenon. The conductor grounds at the end and the end of the body.

### DETAILED DESCRIPTION OF THE INVENTION

Around 1990, it had some imagination. I thought “The car is doing the structure which can not get electricity from outside. What car does the car which can get electricity become?” As the form of the car which can get electricity from outside, it loaded a solar panel into the car but it occurred to me.

The inventor was inquiring about the improvement in fuel consumption of a passenger car the middle of the 1990s. The inventor examined what goods there were for the car. When the goods which raise fuel consumption were attached several articles, the effectiveness of the one like multiplication was shown in improvement in fuel consumption, and the improvement in about 90% of fuel consumption was attained comparatively simply

However, the car became insufficient to be electric and the ride feeling became bad. Reason suited having decreased unusually, when the engine total rotational frequency made it move to a destination point from a depature point. The goods in a car accessory store etc. and the thing which is effective against the improvement in fuel consumption which comes out to the bibliography of books What reduces the angular moment although it rotates from [0014-1] engine to a tire, What is made to promote efficiently the fuel explosion per shot within the cylinder of [0014-2] engine, and shows the big force, By telling even a tire, without losing the power generated from the reducing-excessive weight which appears in [0014-3] vehicle [0014-4] engine as much as possible, these have lowered dramatically the total rotational frequency of the engine at the time of a vehicle moving in the fixed section. Since there was little total rotation of an engine, it became the vehicle which is seldom going to make the electrical and electric equipment.

It judged that the reconstruction which incorporates the electrical and electric equipment was required for this vehicle, the solar panel was attached with the juxtaposition bond to the dc-battery, and semiconductor diode was put in into the circuit of a solar panel and a dc-battery for the antisuckback. Semiconductor diode of an antisuckback was considered as forward direction connection to the solar panel. This used solar panel was far smaller than the current last mold for the first time. It installed in the windshield place by the window in the car. In spite of having been small, there was sufficient effectiveness. The difficulty of riding and sense of incongruity by electric lack were also lost suddenly. The Nighttime transit without charge did not make the badness of a degree of comfort start by the charge from the small solar panel of day ranges, either. Moreover, although it was small some, the improvement in fuel consumption also raised this solar panel.

Then, the improvement in fuel consumption was aimed at further, and the small solar panel was installed also in the in-the-car rear glass place by the window. By this, when the daylight of a constant rate was daytime, it was stabilized and inserted in the solar panel of a windshield place by the window or an in-the-car rear glass place by the window, and stable transit of the improvement in fuel consumption and a vehicle was realized effectively. Two arrangement showed the effectiveness of being twice [more than] many as one-place arrangement.

At this time, the improvement in fuel consumption was attained to about a little less than 100%. The cheap goods which newly become fuel-efficient again were found, and it carried in the vehicle in the car accessory store. Although there were such three goods in all, and the schedule must have attained improvement in 115% or more of fuel consumption at the time, it stopped at the improvement in fuel consumption of a little less than 105% in practice. This was “leveling-off” phenomenon of the improvement in fuel consumption. It is hardly inelastic as elongation and a certain height are approached with vigor sufficient at first like the graph in the left half of the parabola of facing up which stretches up by the upward rise firm finally in the beginning although extended like the graph of upward direct proportion in fuel consumption in the phase of the several in the beginning in the figure in which it occurred at the end since the goods which raise fuel consumption were attached in the letter of multiplication. This phenomenon, fuel consumption of being inelastic was sensed remarkable more in the hit of 105% of improvement in fuel consumption.

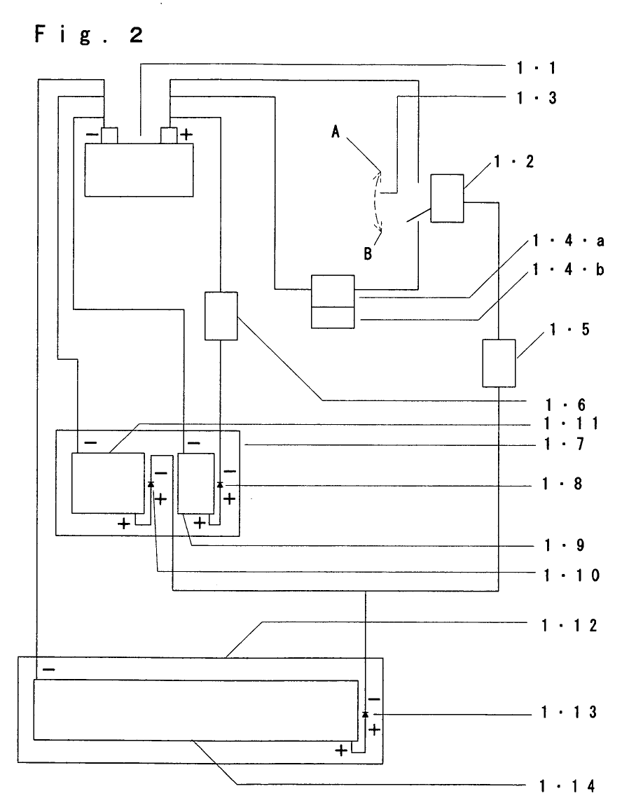

Here, the solar panel was enlarged. This was the thing of the 1st example of FIG. 2, and the thing of the almost same magnitude. There was big effect. The improvement in fuel consumption of 140-160% or more was caused. Separately, for a cooler, the first standup of cooler effectiveness is the good point, it was able to ride more calmly including the time of an idling, and having got cold firmly early. The speed of a vehicle was having seldom fallen even if it put in the cooler. When there was electrical and electric equipment perfectly, the goods which carry out improvement in fuel consumption reacted firmly.

However, it might be a little worrisome. Although only one piece was used, in three weeks, the power in a dc-battery wants to considerable-decrease and to have come to exchange for a dc-battery life two year and, 40,000K of mileage lives, and size called 38B19. If solar panel equipment with an output, of in-the-car installation by the window, of 7 W is always performed by connection, it would be overcharged to the dc-battery and the life will have been contracted considerably. The dc-battery of 38B19 is sold at current, of about 1900 yen, in the home center, and although it is satisfactory in cost, carrying out dc-battery exchange at a pace once at three weeks gets tired with those who manage an automobile. Then, connection was made only the small solar panel, and when starting a vehicle, it was always made into the form where a driver inputs a big solar panel manually by using an on/off switch. The driver was the thing which I have used as cutting of an input in an input and the OFF after operation by ON before operation from a driver's seat. Moreover, when it is stabilized from an AC dynamo when carrying out long-distance migration of the highway, and power was inputted greatly and the electrical and electric equipment was greatly inputted also from a solar panel, consideration which can be used for a dc-battery also as cutting of the input under operation by the driver in the case of being overcharged was also carried out, and, in addition, the on/off switch was formed also for small solar panels. How to use the small on/off switch for solar panels is usually kept carried out to “ON” of an input. The tongue of two on/off switches was installed for becoming the right back of a handle, and the right of an instrument. By the way, there was a problem also in the on/off switch of a big solar panel. although it is troublesome to turn this switch on and off, and it forgets to turn off cutting of an input or there is also what no reason for scientific at the moment of putting in off, when a driver gets off a vehicle—a thing—it is lonesomely wasteful—that it is as becoming a temper, has posed a problem.

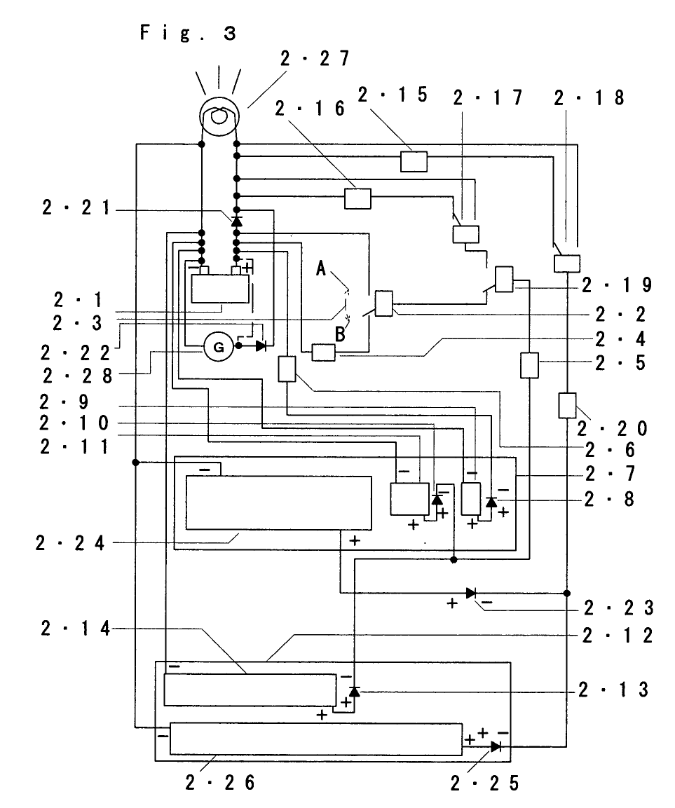

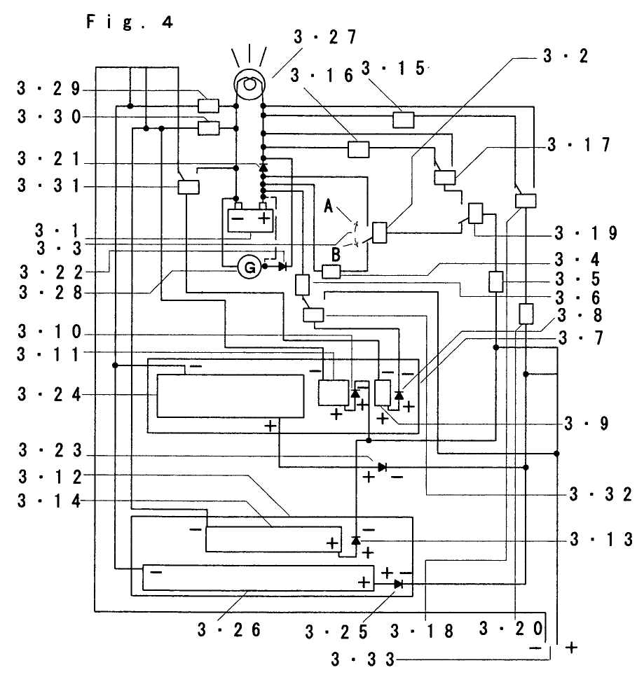

Then, the toggle switch from which flow can be chosen in the direction of (A) or the direction of (B) for electric flow with a switch tongue was prepared between wiring of a dc-battery and an on/off switch. that through which the flow (A) of the end of a toggle switch flows to the plus pole of a dc-battery with former—the lead wire of the flow in the case of an end (B) has already been put in the fuse. This fuse inserts the key of a vehicle in ignition, in case keys are “on” and “acc”, it flows with the plus pole of a dc-battery, and when the time of being “lock” when not being with the time of the key being inserted and a key are “start(s)”, it does not flow with the plus pole of a dc-battery. The ignition switch and relay which give semantics to twisting a key were used. When not riding in a vehicle, the toggle switch is surely set to (B). There is no electrical input from a middle-scale solar panel at this time. In case a vehicle is driven, (B) is still sufficient, it is good as for (A) and the electrical input from a middle-scale solar panel is accepted at this time. The way of riding with good mileage, (A) resembles before by 5 minutes of making a car start out as the example and changes. It begins charging to the battery with the big solar panel. It starts a 5 minutes after engine and it starts out. It stops an engine if arriving at the destination and it gets off the changing car to (B). The user-friendly way of riding tampers also neither with a toggle switch nor an on/off switch by carrying out with maintaining the condition of (B), but departs from a vehicle. As for a vehicle, the key under automobile operation receives the electrical input from a middle-scale solar panel during “on.” Also when getting off a vehicle, it does not tamper with a toggle switch and an on/off switch. Those who do not know the system of this vehicle could also drive this vehicle freely by this, and fuel consumption was also able to be run well calmly. Wiring with which those who do not know the system of this vehicle can also ride freely was inherited by the 1st example of FIG. 2 the 2nd example of FIG. 3, and the 3rd example of FIG. 4. The tongue of a toggle switch itself is installed immediately in the tongue side of two on/off switches, and the driver enabled it to operate it from a driver's seat. The toggle switch was prepared in this way, and since it did not have the electrical and electric equipment but the battery life of 38B19 was so user-unfriendly that it said that the engine was not started in the place which it said from 11 months was about 20 months, the electrical and electric equipment was decreasing at least to the sensibility referred to as wanting to change to a new article(a new car-battery). Moreover, but to do a few use improving when getting in the car is bad, the shutter of the material with which battery life is prolonged, and the way which always made the solar panel of connection the smaller thing judges that cost and an effort decrease generally, and does not let light pass on a small solar panel is attached, and it enabled it to adjust light income while not getting on on a stepless story. A shutter is opened width in the case of parking to a dark place. A shutter is considerably opened thinness in the case of parking to a bright place. The conditions from which a location differs are controllable by this at the time of standby of an automobile. In the case of the common passenger car, the maximum of permission of the amount of solar panel generations of electrical energy was left to the electrical-potential-difference value and supplementary current current value of a dc-battery. That is, in order in other words to large-scale magnified this middle-scale solar equipment, the semiconductor diode which does not carry out an electrical input is attached to a dc-battery, or alternative pathway is formed, and a considerable big large-scale solar panel can be carried by attaching the solar equipment of the part which does not have an electric inflow in a dc-battery. The model to which this large-scale magnified was carried out became the 2nd example of FIG. 3, and the 3rd example of FIG. 4. Old reconstruction does not need the fine adjustment by a pro's automotive engineer, for example, adjustment like computer rewriting.

When placing a considerable big solar panel, there is no space excluding the outside of a vehicle remains.

the capacity of the goods which are useful to the improvement in fuel consumption which is not what originally stops at it although an attractive change is directed even if it puts the equipment which the artificer made on an ordinary vehicle, and which can be found in a car accessory store etc.—about twice—having pulled is another purpose of this equipment. The meaning of this equipment creation aims at the improvement in fuel consumption 100% in the improvement in 160% fuel consumption conventional in daytime, and Nighttime.

It was judged that the technique of the present improvement in automobile fuel consumption had a too weak cure to an electrical input. Solar panel equipment (in the case of FIG. 2, it is 1-7 and 1-12) (in the case of FIG. 3, it is 2-7 and 2-12) (in the case of FIG. 4, it is 3-7 and 3-12) was put on two a front place by the window and the rear insides by the window as the electrical input approach, stable power generating was secured at the time of transit in the daytime, and it considered as the juxtaposition bond to the dc-battery of an automobile. The semiconductor diode of forward direction connection was attached to each solar panel, and it considered as the electric antisuckback. The solar panel (1-9 of FIG. 2) (2-9 of FIG. 3) of shutter loading which outputs 0.3 W (3-9 of FIG. 4) always Connection, The solar panel with which 7 W is outputted in the case of FIG. 2 (1-11 and 1-14 of FIG. 2), The solar panel with which 32.8 W is outputted in the case of FIG. 3 (2-11, 2-14, 2-24, and 2-26 of FIG. 3), The solar panel (3-11, 3-14, 3-24, and 3-26 of FIG. 4) with which 32.8 W or more is outputted in the case of FIG. 4 wired so that it might be connected at the time of automobile use, and it considered consideration of the longevity life of a dc-battery as the goodness of user-friendliness. When it lapses into the situation which overcharge generates at the time of transit, the on/off switch (1-5 and 1-6 of FIG. 2) (2-5, 2-6, and 2-20 of FIG. 3) (3-5, 3-6, 3-20, 3-29, and 3-30 of FIG. 4) from which all solar panel circuits are cut is formed. The toggle switch (2-2, 2-17, and 2-18 of FIG. 3) (3-2, 3-17, and 3-18 of FIG. 4) (1-2 of FIG. 2) always changed from “the connection in automobile use only” also to “the connection, meaning of always connecting” is prepared. These switch tongues were put on the place which can be operated during operation from a driver's seat. The above is the mechanism which reduces that the driving of a car is tired by suppressing the quantity of electricity fluctuation. It is the device which is [an automobile ] dirt-hard and carries out it by electric supply. The electrical and electric equipment is the device which lowers the establishment which makes the allowance of transit of an automobile, and the allowance to the driver who drives an automobile from a certain thing, and causes a traffic accident by it fully. Daytime it is the mechanism which reduces a load to the car machine to the idling when congested, to the car air-conditioning use.

According to invention of claim 1, one solar panel has the small-scale maximum output at 0.3 W or less, and it always connects with a dc-battery, and charge of a dc-battery is possible, and it is possible for the battery to charge while the other solar panel suppresses that a solar panel above being medium-size is always connected because the maximum output is medium-size from 7 watts to 9 watts and it is a connection in car use and that the lifetime of the battery becomes short with overcharge. Moreover, by preparing a light income control shutter plate(a generating power stepless modification controller with the shutter plate) in a small-scale solar panel, a dc-battery can be made to charge for a little electric power, and the life of a dc-battery can be lengthened more. Furthermore, according to invention of claim 2, since a middle-scale solar panel can change from “the connection in automobile use only” also to “the connection, meaning of always connecting”, a middle-scale solar panel can powerfully charge to a dc-battery before automobile start. According to invention of claim 3, the coating pill for the vehicle to have applied to the car body, part and car body by the invention this time which used a solar panel can receive the circulation and the discharge of the electricity while this equipment receives light such as sunshine. It places car body metal itself and a metallic part, the coating pill for the vehicle, the others to have applied to the car body under the electric anticorrosion phenomenon by this. It starts the reduction of the dirty adhesion of the car and the car part. It makes the effect of the car body protection pill more powerful and also it makes effect long, it increases a blaze.

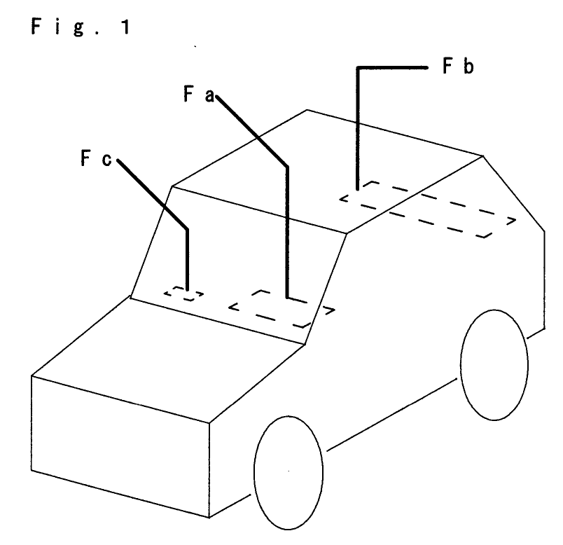

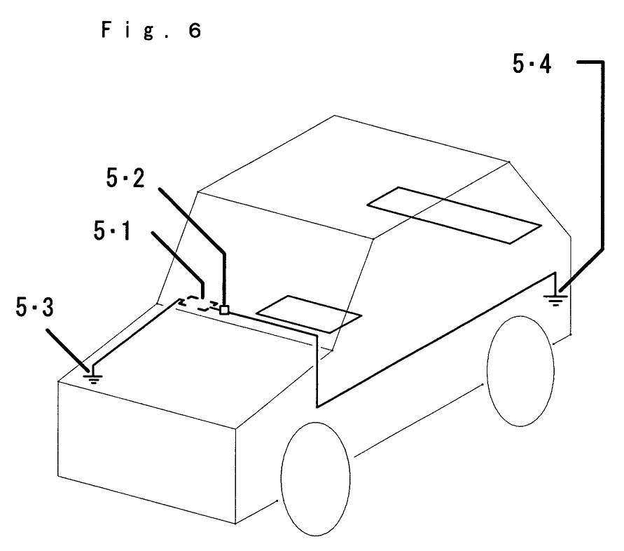

Hereafter, this invention is explained to a detail based on an illustration implementation gestalt. FIG. 1 expresses the appearance of the automobile furnished with the equipment of the 1st example and FIG. 2 of this invention, the 2nd example and FIG. 3, and the 3rd example and FIG. 4. In order to make an automobile into the specification which also runs sunlight as a fuel in addition to a gasoline, gas oil, etc. and air, as the form of FIG. 1, it is putting solar panel equipment on the inner 2 place in case of the front desk window of the car and the rear window. Fc of FIG. 1 is the equipment which is shown with FIG. 6. The equipment of FIG. 6 is making discharge the flow of the electricity with the circulation to the car body while the solar panel is generating electricity.

If it is asked about the place for solar equipment whether to be in the car why by FIG. 1, a reason will be for placing cheap light simple equipment because it is not a strong waterproofing specification, since it is long lasting, in order not to take out the grotesqueness of the appearance by having placed out of the vehicle. A reason of the two front rear insides by the window are raising improvement in fuel consumption, the stability of an automobile of transit, and the amenity by it being stabilized and light being received.

### (THE 1ST EXAMPLE) FIG. 2

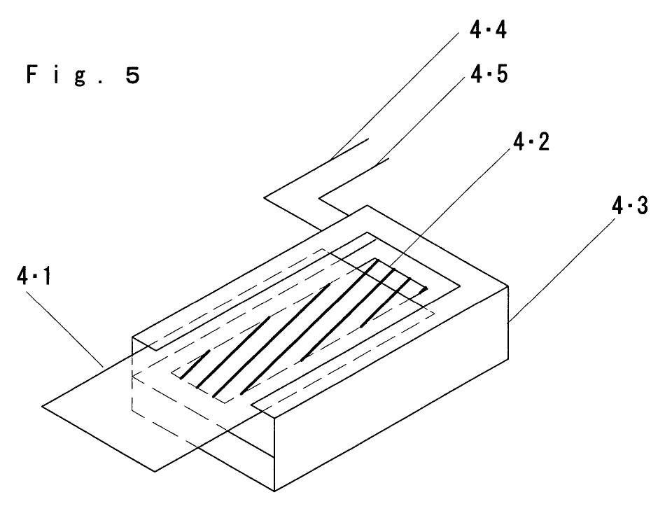

The place for solar panel equipment (sign 1-7) (sign 1-12) has two-place composition of a front and the rear windowpane inside, respectively. (Sign 1-7) (sign 1-12)The plate for carrying the solar panel and semiconductor diode of equipment should be a material which hardly conducts the electrical and electric equipment. A material is easy to be the thing of a general plastics system. The material which is not transformed in daylight is desirable. It is better to be the material which cannot start a fire easily. (Sign 1-7) The magnitude of equipment is 13 mm from 4 mm in thickness of the equipment containing 200 mm long, 341 mm wide, a solar panel, and semiconductor diode. (Sign 1-12) The magnitude of equipment is 13 mm from 4 mm in thickness of the equipment containing 200 mm long, 680 mm wide, a solar panel, and semiconductor diode.

[paragraph-P1] In FIG. 2, the all time connection “always-on connection” is made the solar panel No.1(sign 1-9) with 15V 0.02 A 0.3 W small output in the daytime, and it has the light income control shutter plate(a generating power stepless modification controller with the shutter plate) which shows only this small solar panel No.1 (sign 1-9) by FIG. 5. By the way, also in FIG. 3 (sign 2-9) and FIG. 4 (sign 3-9), it has the light income control shutter of FIG. 5. There are (sign 1-8) for an electric antisuckback with the semiconductor diode No.1 of maximum rating 30V 0.45 A, they are attached by forward direction connection to a solar panel No.1 (sign 1-9), and are attached by hard flow connection to a 38B19 mold dc-battery (sign 1-1). It has prevented the electrical and electric equipment of a dc-battery (sign 1-1) being opened, and passing along the inside of a solar panel to hard flow by this electric antisuckback circuit. Moreover, all semiconductor diodes (being all of the semiconductor diodes of FIG. 3, FIG. 4 in addition to FIG. 2) in addition to (sign 1-8) are attached for the electric antisuckback. Making it charge has a little charge meaning of this wiring and a stepless light income control shutter. It was judged that battery life is prolonged and the cost and the effort of dc-battery exchange decrease generally that there was less sunlight charge while having not ridden in an automobile, although it rode in the vehicle and the user-friendliness was inferior a little. Moreover, it is better for the user-friendliness at the time of seeing in the period of one year, one year, and a half half a year to restrict light income so far rather. Although there are probably some persons who think that it is at that which the way which does not charge while having not ridden in a vehicle at all rather says, when it does so, any benefit can hardly be found to transit of night. Moreover, daytime and night do not have fun in a vehicle running and taking out, and when a car begin to run, especially the fuel consumption at the time is not necessarily good. The effectiveness that a vehicle dirt-comes to be hard becomes weak unusually. From the above reason, such a configuration of the solar panel of the all time connection is also set not only in (the 1st example) (the 2nd example) (the 3rd example). During transit, the on/off switch of (sign 1-6) was formed as consideration which can be used for a dc-battery also as cutting of the input under operation by the driver in the case of being overcharged, when it was stabilized, power was greatly inputted from an AC dynamo and the electrical and electric equipment was greatly inputted also from a solar panel. The on/off switch was installed in the place which can be operated from a driver's seat while a driver operates. Moreover, for the same purpose, the following on/off switches (sign 1-5) (sign 2-5) (sign 2-6) (sign 2-20) (sign 3-5) (sign 3-6) (sign 3-20) are also installed in the place which can be operated from a driver's seat, while a driver operates.

In FIG. 2, the connection at the time of automobile use, uses 14V 0.4 A 5.6 W as the solar panel No. 3 (sign 1-14) of an output for 15V 0.07 A 1.05 W the solar panel No. 2 (sign 1-11) of an output, and in the daytime in the daytime. A solar panel No.2 (sign 1-11) is accompanied by the semiconductor diode No. 2 (sign 1-10) of maximum rating 40V 3 A as an electric antisuckback circuit. A solar panel No. 3 (sign 1-14) is accompanied by the semiconductor diode No. 3 (sign 1-13) of maximum rating 40V 5 A as an electric antisuckback circuit.

It flows with the plus pole of a dc-battery only in the case of “on” and “acc”, and since a solar panel No. 2 (sign 1-11) and No. 3 (sign 1-14) are considered as connection at the time of automobile use, when the key of a vehicle is twisted in ignition, when the electrical and electric equipment is an outflow, and keys are “lock” and “start”, wiring of not being connected can be easily made from using an ignition switch and a relay function. Since lead wire passes along a relay when this ignition switch and a relay function are used, in FIG. 3 and FIG. 4, it is expressed only as the relay. They are (Sign 2-4) (sign 2-15) (sign 2-16) (sign 34) (sign 3-15) (sign 3-16). In FIG. 2, it expressed as “a relay (sign 1, 4,a)”, “fuse and a fuse box(sign 1, 4,b)”. When user twist ignition, the lead wire by the side of plus of solar panels No. 2 (sign 1-11) and No. 3 (sign 1-14) of the antisuckback circuit of a between, they are connected with the fuse (sign 1, 4,b) with which it flows with the plus pole of a dc-battery only in the case of “on” and “acc”. FIG. 3 setting (sign 24) (sign 2-15) (sign 2-16)-FIG. 4 also setting (sign 34) (sign 3-15) (sign 3-16)—it considers as connection by the almost same approach at the time of automobile use.

[paragraph-P2] (Sign 1-2) Toggle switch. This toggle switch can choose electric flow as the direction of (A), or the direction of (B) with a switch tongue. It is shown that wiring changes if (sign 1-3) move a toggle switch tongue. The place by which through connection is made in lead wire in “FIG. 2” to the relay (sign 1, 4,a) fuse (sign 1, 4,b) of the direction of (B). If a tongue is changed and it is the direction of (A), it will be connected from a toggle switch through lead wire to the plus pole of a dc-battery. The situation which (A) in “FIG. 2” show is not connected in the direction of (A). A change can be changed by moving a tongue, the direction connection of (B) can be cut, and it can tie to the direction connection of (A). (A) Direction connection means “always-on connection.” The situation which (B) in “FIG. 2” show is connected in the direction of (B). (B) Direction connection means “connecting at the time of automobile use.” When not riding in a vehicle, the toggle switch is surely set to (B). The electrical input from the middle-scale solar panel No. 2 (sign 1-11) and No. 3 (sign 1-14) are not at this time. In case a vehicle is driven, (B) is still sufficient, it is good as for (A) and the electrical input from the middle-scale solar panel No. 2 (sign 1-11) and No. 3 (sign 1-14) are accepted at this time. The way of riding with good mileage, (A) resembles before by 5 minutes of making a car start out as the example and changes. It begins charging to the battery with the big solar panel. It starts a 5 minutes after engine and it starts out. It stops an engine if arriving at the destination and it gets off the changing car to (B). The user-friendly way of riding tampers also neither with a toggle switch nor an on/off switch by carrying out with maintaining the condition of (B), but departs from a vehicle. As for a vehicle, the key under automobile operation receives the electrical input from a middle-scale solar panel No. 2 (sign 1-11) and No. 3 (sign 1-14) during “on.” Also when getting off a vehicle, it does not tamper with a toggle switch and an on/off switch. Those who do not know the system of this vehicle could also drive this vehicle freely by this, and fuel consumption was also able to be run well calmly. Wiring with which those who do not know the system of this vehicle can also ride freely was inherited by the 1st example of FIG. 2, the 2nd example of FIG. 3, and the 3rd example of FIG. 4. The tongue of a toggle switch itself is installed immediately in the tongue side of two on/off switches, and the driver enabled it to operate it from a driver's seat.

### (THE 2ND EXAMPLE) FIG. 3

The place for solar panel equipment (sign 2-7) (sign 2-12) has two-place composition of a front and the rear windowpane inside, respectively, it is the same in [as the 1st example (sign 1-7) (sign 1-12)] arrangement, enlargement is carried out, and the work accompanying enlargement is carried out.

Above-mentioned paragraph of the small solar panel No. 1 (sign 1-9) (the 1st example)—although it becomes the same contents of description in [paragraph-P1] from here, in FIG. 3, the all time connection “always-on connection” is made the solar panel No.1(sign 2-9) with 15V 0.02 A 0.3 W small output in the daytime, and it has the light income control shutter plate(a generating power stepless modification controller with the shutter plate) which shows only this small solar panel No.1 (sign 2-9) by FIG. 5. There are (sign 2-8) for an electric antisuckback with the semiconductor diode No. 1 of maximum rating 30V 0.45 A, they are attached by forward direction connection to a solar panel No.1 (sign 2-9), and are attached by hard flow connection to a 38B19 mold dc-battery (sign 2-1). It has prevented the electrical and electric equipment of a dc-battery (sign 2-1) being opened, and passing along the inside of a solar panel to hard flow by this electric antisuckback circuit. The semantics of this wiring and a stepless light income control shutter—the above-mentioned paragraph—it is the same with having stated with [paragraph-P1]. During transit, the on/off switch of (sign 2-6) was formed as consideration which can be used for a dc-battery also as cutting of the input under operation by the driver in the case of being overcharged, when it was stabilized, power was greatly inputted from an AC dynamo and the electrical and electric equipment was greatly inputted also from a solar panel.

It sets to FIG. 3 and is connection at the time of automobile use,

It is the solar panel No. 2 (sign 2-11) of an output about daytime and 15V 0.07 A 1.05 W,

It is the solar panel No. 3 (sign 2-14) of an output about daytime and 14V 0.4 A 5.6 W,

It is the solar panel No. 4 (sign 2-24) of an output about daytime and 14V 0.85 A 11.9 W,

In the daytime, let 14V 1.0 A 14 W be the solar panel No. 5 (sign 2-26) of an output.

A solar panel No. 2 (sign 2-11) is accompanied by the semiconductor diode No. 2 (sign 2-10) of maximum rating 40V 3 A as an electric antisuckback circuit.

A solar panel No. 3 (sign 2-14) is accompanied by the semiconductor diode No. 3 (sign 2-13) of maximum rating 40V 5 A as an electric antisuckback circuit.

A solar panel No. 4 (sign 2-24) is accompanied by the semiconductor diode No. 4 (sign 2-23) of maximum rating 100V 3 A as an electric antisuckback circuit.

A solar panel No. 5 (sign 2-26) is accompanied by the semiconductor diode No. 5 (sign 2-25) of maximum rating 100V 3 A as an electric antisuckback circuit.

In order to be a solar panel No. 2, No. 3, No. 4, and No. 5 (sign 2-11) (sign 2-14) (sign 2-24) (sign 2-26) as connection at the time of automobile use, an ignition switch and a relay function are used. That is, when the key of a vehicle is twisted in ignition, it flows with the plus pole of a dc-battery only in the case of “on” and “acc”, and wiring of not being connected is used, when the electrical and electric equipment is an outflow and keys are “lock” and “start.” For example, this wiring can be made, if approaches, such as the flowing fuse tying to the plus pole of a dc-battery only in the case of “on” and “acc”, are taken when ignition is twisted. (Sign 2-4) (sign 2-16) (sign 2-15)With a relay, connection is materialized at the time of automobile use in case keys are “on” and “acc”.

About a toggle switch (Sign 2-2) (sign 2-17) (sign 2-18) what can choose electric flow as the direction “always-on connection” of (A) where this toggle switch does not have a relay, or the direction “connect at the time of automobile use” of (B) with a relay with a switch tongue. It is shown that wiring changes if (sign 2-3) move a toggle switch tongue. The place by which through connection is made in lead wire in “FIG. 3” to the relay (sign 2-4) of the direction of (B). If a tongue is changed and it is the direction of (A), it will be connected from a toggle switch through lead wire to the plus pole of a dc-battery, and will always be connected.

The situation which (A)- and “FIG. 3” show is not connected in the direction of (A). (A) Direction connection means “always-on connection.”

The situation which (B)- and “FIG. 3” show is connected in the direction of (B). (B) Direction connection means “connecting at the time of automobile use.”

The toggle switch (sign 2-2) (sign 2-17) (sign 2-18) of how to catch the concept of the direction “always-on connection” of (A) without a relay and the direction “to connect at the time of automobile use” of (B) with a relay is the same, and when not riding in a vehicle, the toggle switch is surely carried out in the direction of (B) with a relay circuit. A reason—the above-mentioned paragraph—[paragraph-P1] has described. The tongue of a toggle switch itself was put on the place which can be operated from a driver's seat, and it was installed immediately in the on/off switch tongue group side. The change which an artificer considers although what is necessary is just to change it freely if the change of the tongue of a toggle switch understands the automobile operator for reason—the above-mentioned paragraph—it is the approach stated also with [paragraph-P2] for inventing.

[paragraph-P3] It is that the specification from which FIG. 3 (The 2nd example) and FIG. 2 (the 1st example) differ notably has attached semiconductor diode and maximum rating 200V 60 A (sign 2-21) maximum rating 200V 60 A (sign 2-22). At the time of automobile use of (the 1st example), for the further enlargement of a connected solar panel, this was attached in order not to carry out a big electrical input to a dc-battery from a solar panel. A dc-battery does not desire too much big overcharge. Moreover, if it puts in another way, although the cure against overcharge should be first taken into consideration when the big electrical and electric equipment occurs by the specification of this (the 2nd example) FIG. 3, it will become a dc-battery (sign 2-1). (the 1st example) comparing (the 2nd example), the part of solar panel No. 4 14V 0.85 A 11.9 W output (sign 2-24) solar panel No. 5 14V 1.0 A 14 W output (sign 2-26) and the solar panel generator are large. (Sign 2-24)(sign 2-26) in order not to make electric generating power input into a dc-battery (sign 2-1), semiconductor diode (sign 2-21) (sign 2-22) is attached. Although (sign 2-22) look unnecessary by FIG. 3, when the bonnet of an automobile is opened, it actually turns out that it is natural to make it wiring as shown by FIG. 3. Although connection of an AC dynamo (sign 2-28) and the dc-battery (sign 2-1) is carried out with the broken line, this broken line means the connection of plus poles.

[paragraph-P4] About the toggle switch of FIG. 3 (sign 2-19). The thing of this toggle switch being what was prepared for the strong day of strong seasons of sunlight, such as a summer, and sunlight, and not making the electric generating power of a part connected solar panels(sign 2-11) (sign 2-14) to the direction side where FIG. 3 is not connected input into a dc-battery (sign 2-1) a strong season of sunlight and in the daytime. The overcharge to a dc-battery is avoided. The condition of connection of FIG. 3 is making the electric generating power of a part of being a setup of weak of sunlight (sign 2-11) (sign 2-14) input into a dc-battery (sign 2-1).

### (THE 3RD EXAMPLE) FIG. 4

Although the place for solar panel equipment (sign 3-7) (sign 3-12) has two-place composition of a front and the rear windowpane inside, respectively and is the same fundamentally in [as the 1st example (sign 1-7) (sign 1-12)] arrangement a part to be unable to put on a front and the rear windowpane inside any longer with the 2nd example or more enlargement is premised on installing outside vehicles, such as a roof of a vehicle. The solar panels No. 4(sign 3-24) and No. 5(sign 3-26) divide, and is installed outside in the car and a vehicle.

Above-mentioned paragraph of the small solar panel No. 1 (sign 1-9) (the 1st example)—although it becomes the same contents of description in [paragraph-P1] from here, in FIG. 4, the all time connection “always-on connection” is made the solar panel No.1(sign 3-9) with 15V 0.02 A 0.3 W small output in the daytime, and it has the light income control shutter plate (a generating power stepless modification controller with the shutter plate) which shows only this small solar panel No.1 (sign 3-9) by FIG. 5. There are (sign 3-8) for an electric antisuckback with the semiconductor diode No. 1 of maximum rating 30V 0.45 A, they are attached by forward direction connection to a solar panel No.1 (sign 3-9), and are attached by hard flow connection to a 38B19 mold dc-battery (sign 3-1). It has prevented the electrical and electric equipment of a dc-battery (sign 3-1) being opened, and passing along the inside of a solar panel to hard flow by this electric antisuckback circuit. The semantics of this wiring and a stepless light income control shutter—the above-mentioned paragraph—it is the same with having stated with [paragraph-P1]. During transit, the on/off switch of (sign 3-6) was formed as consideration which can be used for a dc-battery also as cutting of the input under operation by the driver in the case of being overcharged, when it was stabilized, power was greatly inputted from an AC dynamo and the electrical and electric equipment was greatly inputted also from a solar panel.

It sets to FIG. 4 and is connection at the time of automobile use,

It is the solar panel No. 2 (sign 3-11) of an output about daytime and 15V 0.07 A 1.05 W,

It is the solar panel No. 3 (sign 3-14) of an output about daytime and 14V 0.4 A 5.6 W,

The solar panel No. 4 (sign 3-24) of a bigger output than the 2nd example, FIG. 3, (sign 2-24) 14V 0.85 A 11.9 W output,

It considers as the solar panel No. 5 (sign 3-26) of a bigger output than the 2nd example, FIG. 3, (sign 2-26) 14V 1.0 A 14 W output.

A solar panel No. 2 (sign 3-11) is accompanied by the semiconductor diode No. 2 (sign 3-10) of of maximum rating 40V 3 A as an electric antisuckback circuit.

A solar panel No. 3 (sign 3-14) is accompanied by the semiconductor diode No. 3 (sign 3-13) of maximum rating 40V 5 A as an electric antisuckback circuit.

A solar panel No. 4 (sign 3-24) is accompanied by the semiconductor diode No. 4 (sign 3-23) which has 3 or more times of the electrical potential difference and current which a solar panel No. 4 (sign 3-24) outputs in the maximum rating as an electric antisuckback circuit.

A solar panel No. 5 (sign 3-26) is accompanied by the semiconductor diode No. 5 (sign 3-25) which has 3 or more times of the electrical potential difference and current which a solar panel No. 5 (sign 3-26) outputs in the maximum rating as an electric antisuckback circuit.

In order to be a solar panel No. 2, No. 3, No. 4, and No. 5 (sign 3-11) (sign 3-14) (sign 3-24) (sign 3-26) as connection at the time of automobile use, an ignition switch and a relay function are used. That is, when the key of a vehicle is twisted in ignition, it flows with the plus pole of a dc-battery only in the case of “on” and “acc”, and wiring of not being connected is used, when the electrical and electric equipment is an outflow and keys are “lock” and “start.” For example, this wiring can be made, if approaches, such as the flowing fuse tying to the plus pole of a dc-battery only in the case of “on” and “acc”, are taken when ignition is twisted. (Sign 3-4) (sign 3-16) (sign 3-15)With a relay, connection is materialized at the time of automobile use in case keys are “on” and “acc”.

About a toggle switch (Sign 3-2) (sign 3-17) (sign 3-18) what can choose electric flow as the direction “always-on connection” of (A) where this toggle switch does not have a relay, or the direction “connect at the time of automobile use” of (B) with a relay with a switch tongue. It is shown that wiring changes if (sign 3-3) move a toggle switch tongue. The place by which through connection is made in lead wire in “FIG. 4” to the relay (sign 3-4) of the direction of (B). If a tongue is changed and it is the direction of (A), it will be connected from a toggle switch through lead wire to the plus pole of a dc-battery, and will always be connected.

The situation which (A)- and “FIG. 4” show is not connected in the direction of (A). (A) Direction connection means “always-on connection.”

The situation which (B)- and “FIG. 4” show is connected in the direction of (B). (B) Direction connection means “connecting at the time of automobile use.”

The toggle switch (sign 3-2) (sign 3-17) (sign 3-18) of how to catch the concept of the direction “always-on connection” of (A) without a relay and the direction “to connect at the time of automobile use” of (B) with a relay is the same, and when not riding in a vehicle, the toggle switch is surely carried out in the direction of (B) with a relay circuit. A reason—the above-mentioned paragraph—[paragraph-P1] has described. The tongue of a toggle switch itself was put on the place which can be operated from a drivers seat, and it was installed immediately in the on/off switch tongue group side. The change which an artificer considers although what is necessary is just to change it freely if the change of the tongue of a toggle switch understands the automobile operator for reason—the above-mentioned paragraph—it is the approach stated also with [paragraph-P2] for inventing.

The above-mentioned paragraph which described FIG. 3 (the 2nd example)—although it becomes the almost same description as “[paragraph-P3]”, it is that the specification from which FIG. 4 (The 3nd example) and FIG. 2 (the 1st example) differ notably has attached semiconductor diode and maximum rating 200V 60 A (sign 3-21) maximum rating 200V 60 A (sign 3-22). At the time of automobile use of (the 1st example), for the further enlargement of a connected solar panel, this was attached in order not to carry out a big electrical input to a dc-battery from a solar panel. A dc-battery does not desire too much big overcharge. Moreover, if it puts in another way, although the cure against overcharge should be first taken into consideration when the big electrical and electric equipment occurs by the specification of this (the 3rd example) FIG. 4, it will become a dc-battery (sign 3-1). (the 1st example) comparing (the 3rd example), the part of solar panel No. 4 (sign 3-24) solar panel No. 5 (sign 3-26) and the solar panel generator are large. (Sign 3-24)(sign 3-26) in order not to make electric generating power input into a dc-battery (sign 3-1), semiconductor diode (sign 3-21) (sign 3-22) is attached. Although (sign 3-22) look unnecessary by FIG. 4, when the bonnet of an automobile is opened, it actually turns out that it is natural to make it wiring as shown by FIG. 4. Although connection of an AC dynamo (sign 3-28) and the dc-battery (sign 3-1) is carried out with the broken line, this broken line means the connection of plus poles.

About the toggle switch of FIG. 4 (sign 3-19). The above-mentioned paragraph which described FIG. 3 (the 2nd example)—although it becomes the almost same description as “[paragraph-P4]”, the thing of this toggle switch being what was prepared for the strong day of strong seasons of sunlight, such as a summer, and sunlight, and not making the electric generating power of a part connected solar panels(sign 3-11) (sign 3-14) to the direction side where FIG. 4 is not connected input into a dc-battery (sign 3-1) a strong season of sunlight and in the daytime. The overcharge to a dc-battery is avoided. The condition of connection of FIG. 4 is making the electric generating power of a part of being a setup of weak of sunlight (sign 3-11) (sign 3-14) input into a dc-battery (sign 3-1).

About FIG. 4 (sign 3-33). From the view point of the side of the user, it cuts a connection from the solar panel to the car, the desire that the electricity power input to the side of the car can not do and to want to use direct electricity goes out of the solar panel. I want to use the electrical and electric equipment from a solar panel for the notebook computer used in the car and the electric appliances which lengthen and take the electrical and electric equipment from a vehicle in code, and are used outdoor. Then (sign 3-33) took out the terminal of plus and minus. The electrical and electric equipment which comes out from here is 12V a little more than direct-current electrical and electric equipment. What is necessary is for the converter of an electrical-potential-difference rise just to come to hand, if a user is required since the converter to the 100 V alternating current from a direct current of 12V is sold at a low price at the store in a town now. In consideration of possibility that an unstable element will be generated with the electrical and electric equipment with which it flows on a vehicle and which comes out, and the electrical and electric equipment which flows from a vehicle and which comes out, the on/off switch(Sign 3-29) (sign 3-30) was attached in order to cut an unstable element. Although there was also a toggle switch(Sign 3-31) (sign 3-32) in order to cut the unstable element by the electrical and electric equipment with a vehicle, it considered as the specification of the change of “always-on connection with a dc-battery”, and “the power source for the exteriors which the vehicle became independent of”.

About FIG. 5. FIG. 5 is the situation of the shutter attached on the solar panel of FIG. 2 (sign 1-9) FIG. 3 (sign 2-9) FIG. 4(sign 3-9). Light income can be adjusted by making a shutter slide. Slight little serves as a base considerably.

(Sign 4-1) The shutter plate of the material which does not let light pass. Moreover, if the shutter plate of a ground glass pattern or blue transparence is pulled and each of the duplexes is taken in and out of under the shutter plate which does not let light pass as a duplex shutter by liking, the impression when appearing in a vehicle changes and various effectiveness can be enjoyed.

(Sign 4-2) is the solar panel itself. It is equivalent to FIG. 2 (sign 1-9), (the sign 2 and 9) of FIG. 3, and (the sign 3 and 9) of FIG. 4.

(Sign 4-3) The box currently held so that a shutter may not slip down

(Sign 4-4) Lead wire which faces to a minus terminal so that it may become a dc-battery and a juxtaposition bond

(Sign 4-5) Lead wire which faces to a plus terminal so that it may become a dc-battery and a juxtaposition bond

About FIG. 6. FIG. 6 is equipment in the place to be shown in Fc of FIG. 1. While the “always-on connection” solar panel (sign 5-1) generating electricity, the electricity circulates to the car body and the part among the grounding points which were connected with the car end (sign 5-3) and the end (sign 5-4) and the equipment of FIG. 6 is flowing.

(Sign 5-1)

As for the size of the solar panel(sign 5-1), the maximum output is 14 volt 3 amperes beforehand from 0.25 volt 0.03 amperes. It causes a fire and it makes the electric current and the voltage of the level that there there is not an influence in the human body.

(Sign 5-2)

The on off switch(sign 5-2) put to be able to cancel a connection if that the electricity was flowing was unpleasant.

It says a reason for not being writing down a semiconductor diode in this circuit from the reason and the semiconductor diode is what unpleasant to touch which may not been and are not. It thinks that it is permitted to put a semiconductor diode into the circuit but the inventor doesn't suggest.

The Equipment of FIG. 6

It places car body metal itself and a metallic part, the coating pill for the vehicle, the others to have applied to the car body under the electric anticorrosion phenomenon by this. It starts the reduction of the dirty adhesion of the car and the car part. It makes the effect of the car body protection pill more powerful and also it makes effect long, it increases a blaze. The equipment of FIG. 6 can not contribute to the improvement of the mileage directly but in the car, if kicking a dirty difficulty, the car doesn't become more dirty. The dirtier the car isn't, as for the car, the one which becomes electric resistance decreases because it makes the structure of the body ground, at the gasoline engine car and so on, the firing with the sparking plug is cleaner, becomes strong, and this thing concerns the improvement of the mileage. In this way, the equipment of FIG. 6 contributes to the improvement of the mileage indirectly.

If the improvement 160% and 100% vehicle in fuel consumption spreads through the gasoline-powered vehicle in Japan, it will be thought that Japan can observe carbon-dioxide-emission reduction ratio 6% in the first Kyoto Protocol from 2008 to 2012 and 1990. Moreover, although until is applicable also to a diesel rolling stock, a propane vehicle, an LPG vehicle, a hybrid car, and the Cessna of a also structurally near airplane to some extent, it is thought that the equipment to an ambulance and installation of the way of thinking become fairly popular. It will become the auxiliary device of an auxiliary power unit APU, when it attaches in the jet plane for passengers.

The Explanation of the Sign

FIG. 1

Fa The equipment of the solar of the side of the front desk window

Fb The equipment of the solar of the side of the rear window

Fc The exclusive use solar equipment to prevent from the food, being electric

FIG. 2

1-1 38B19 mold dc-battery

1-2 Toggle switch

1-3 It is shown that wiring changes if a toggle switch tongue is moved.

1, 4,a Relay

1, 4,b A fuse and fuse box

1-5 On/off switch

1-6 On/off switch

1-7 Front aperture side solar equipment

1-8 Semiconductor diode (No.1)

1-9 Solar panel (No.1)

1-10 Semiconductor diode (No. 2)

1-11 Solar panel (No. 2)

1-12 Rear aperture side solar equipment

1-13 Semiconductor diode (No. 3)

1-14 Solar panel (No. 3)

FIG. 3

2-1 38B1 9 mold dc-battery

2-2 Toggle switch

2-3 It is shown that wiring changes if a toggle switch tongue is moved.

2-4 Relay

2-5 On/off switch

2-6 On/off switch

2-7 Front aperture side solar equipment

2-8 Semiconductor diode (No.1)

2-9 Solar panel (No.1)

2-10 Semiconductor diode (No. 2)

2-11 Solar panel (No.2)

2-12 Rear aperture side solar equipment

2-13 Semiconductor diode (No. 3)

2-14 Solar panel (No. 3)

2-15 Relay

2-16 Relay

2-17 Toggle switch

2-18 Toggle switch

2-19 Toggle switch

2-20 On/off switch

2-21 Semiconductor diode

2-22 Semiconductor diode

2-23 Semiconductor diode (No. 4)

2-24 Solar panel (No. 4)

2-25 Semiconductor diode (No. 5)

2-26 Solar panel (No. 5)

2-27 various equipments using the electrical and electric equipment are meant—the light is not only meant

2-28 AC dynamo

FIG. 4

3-1 Automobile dc-battery

3-2 Toggle switch

3-3 It is shown that wiring changes if a toggle switch tongue is moved.

3-4 Relay

3-5 On/off switch

3-6 On/off switch

3-7 Front aperture side solar equipment

3-8 Semiconductor diode (No. 1)

3-9 Solar panel (No. 1)

3-10 Semiconductor diode (No. 2)

3-11 Solar panel (No. 2)

3-12 Rear aperture side solar equipment

3-13 Semiconductor diode (No. 3)

3-14 Solar panel (No. 3)

3-15 Relay

3-16 Relay

3-17 Toggle switch

3-18 Toggle switch

3-19 Toggle switch

3-20 On/off switch

3-21 Semiconductor diode

3-22 Semiconductor diode

3-23 Semiconductor diode (No. 4)

3-24 Solar panel (No. 4)

3-25 Semiconductor diode (No. 5)

3-26 Solar panel (No. 5)

3-27 various equipments using the electrical and electric equipment are meant—the light is not only meant

3-28 AC dynamo

3-29 On/off switch

3-30 On/off switch

3-31 Toggle switch

3-32 Toggle switch

3-33 Direct-current +−pole output terminal

FIG. 5

4-1 Shutter plate

4-2 Solar panel plate

4-3 Container which can slide a shutter plate

4-4 −pole lead wire

4-5 +pole lead wire

FIG. 6

5-1 The exclusive use solar panel for the electric anticorrosion

5-2 On/off switch

5-3 It grounds a conductor from the solar panel at the end of the body of the car.

5-4 It grounds the conductor of (sign5-3) but the pole ((sign5-4) is a −pole if (sign5-3) is a +pole) from the solar panel at the end of the body of the car.

What is claimed is:

1. It has the solar panel of at least two kinds of connection methods to the dc-battery of an automobile.:
Among two kinds of the connection method,
this the first kind of solar panel has a generating power stepless modification controller with the shutter plate which can cover a solar panel as a regulator which can adjust the power of the maximum output produced from a solar panel even to max from 0, and the maximum output is 15V 0.3 W. This first kind of solar panel always connects the dc-battery of an automobile.
And these the second kind of solar panels, “the electric maximum output is from 14V 7 W to 17V 9 W” are connected to this dc-battery only in the case of key switch mode “on” or “acc” when a person twists the key of this automobile in ignition.

2. Electric supplement equipment according to claim 1 is characterized by preparing the toggle switch for a change with which a driver can also operate said the second kind of solar panels connecting style in claim 1 during automobile operation so that it can always change from “the connection in automobile use only, said in claim 1” also to “the connection, meaning of always connecting”.

3. The electric current circulation equipment to apply electricity to the car body in the time which the sun beam falls on is the solar panel equipment by the maximum output, from 0.25 volt 0.03 ampere to 14 volt 3 ampere, to have made a solar panel +pole and a −pole connect with the end and the end of the body metal of the car.
